(19) United States
(12) Patent Application Publication
(10) Pub. No.: US 2024/0221710 A1
(43) Pub. Date: Jul. 4, 2024

(54) DEVICE FOR PROCESSING AN AUDIO SIGNAL

(71) Applicant: MONDAY NOISE, PARIS (FR)

(72) Inventors: Jeremy SAVONET, PIERRE BÉNITE (FR); Antoine PETROFF, PARIS (FR)

(21) Appl. No.: 18/569,531

(22) PCT Filed: Jun. 16, 2022
(86) PCT No.: PCT/EP2022/066507

§ 371 Date: Dec. 12, 2023

(30) Foreign Application Priority Data
Jun. 16, 2021 (FR) 2106365

(51) Int. Cl. G10H 3/18; G10H 1/14; G10H 1/18

(52) U.S. Cl. CPC G10H 3/188; G10H 1/14; G10H 1/18

(57) ABSTRACT

A device for processing an audio signal, includes an acquisition interface of a first analog input signal from an audio source; a first analog-to-digital converter of the first analog input signal to produce a second digital signal; at least one first digital component to perform a first digital equalization of the second digital signal, the first digital equalization being configurable according to first input parameters to produce a third digital signal, a first digital-to-analog converter of the third digital signal to generate a fourth analog signal; an analog processing stage including at least one electronic component having at least one predefined non-linear operating range, the stage being configured to process the fourth analog signal in at least a part of the non-linear operating range in order to generate a fifth analog signal; a second analog-to-digital converter and at least one second digital component to perform a second digital equalization.

### FIELD OF THE INVENTION

The invention relates to the field of effects for musical instruments and/or for voice. More particularly, the invention relates to the field of electronic effects for musical instruments. More particularly, the invention relates to the field of devices for processing an audio signal. The invention also relates to the field of effect pedals for electric guitars.

### PRIOR ART

It is known to use devices for processing an audio signal to modify characteristics of an audio signal. Such devices make it possible for example to change the frequency characteristics of an audio signal, for example by amplifying certain frequencies of the audio signal and by attenuating others thereof. Such a device may also act on the amplitude of the signal, for example the compression thereof.

For example, audio effect pedals intended to be used with electric guitars are known. Effect pedal is taken to mean a device for processing an audio signal from a musical instrument that comprises a foot-operated switch. Generally, effect pedals are used with electric guitars, electric basses, keyboards, synthesizers, voices picked up by a microphone, etc. For example, so-called “overdrive” or saturation effect pedals are known, which will change the frequency characteristics of the audio input signal, the signal amplitude, the signal gain, as well as apply a signal clipping, which may be soft or hard (“soft clipping” or “hard clipping”). Such pedals traditionally use entirely analog processing of the audio signal. As a result, the audio signal only passes through analog components and is never digitized during the process of processing the audio signal by the device. For example, the clipping is traditionally performed by diodes that will be called upon in their non-linear operating range to perform the clipping. Alternatively, transistors, amplification valves, or any other non-linear component may be used to perform the same function. These devices also comprise analog equalization stages of the audio signal. These stages, which may be located upstream and/or downstream of the stage performing the clipping. Such devices have the drawback of not being very versatile, each function requiring the addition of new components. Notably, the circuit of such a device comprises only one type of frequency equalization, each new type of equalization requiring the addition of new components. In addition, in such devices, the signal frequency equalization circuit is closely linked to the clipping circuit, which means that only a frequency setting of the device is actually usable by musicians. It may also be noted that the characteristics of the clipping performed by the clipping circuit are also related to the frequency equalization circuit. Thus, it is difficult to obtain certain combinations of desired clipping quality and type of frequency equalization in a fully analog circuit. In addition, it is not possible in this type of device to retain recorded settings, each setting of the device being carried out by manipulation of potentiometers.

Audio processing devices are also known that use digital technologies to perform the same function as analog processing devices. Such devices comprise analog-to-digital converters to digitize the analog input signal. Next, a digital processing is performed on the signal which next passes through a digital-to-analog converter to be converted into an analog output signal. Usually, the digital processing may be based on an impulse response of a conventional analog effect. Such processing makes it possible to model the frequency characteristics of the signal but is limited to the linear operating domain of the signal. The digital processing may also be based on the digital simulation of each component of the analog reference module. Such devices have the drawback of proposing a digital modeling of the signal that is not perfect. Notably, the non-linearity zones introduced by the analog components are very difficult to model in a way that is faithful and close enough to the processing performed by the original analog component. This difference between the modeling and the result obtained by a digital component leads to a less natural sound that does not fully satisfy musicians. In particular, such devices of such modeled systems do not properly account for the play dynamics of the musician, i.e., variations in amplitude of the signal coming from the musical instrument. It may also be noted that digital signal processors capable of fully modeling the complete processing of the signal are generally quite expensive, which is ultimately of little interest in the context of an audio signal processing device such as an overdrive pedal. This type of modeling is ultimately generally found in “multi-effect” type devices that are not intuitive to use for the musician.

### SUMMARY OF THE INVENTION

The device according to the invention makes it possible to overcome the aforementioned drawbacks.

The invention relates to a device for processing an audio signal comprising:
An interface for acquiring a first analog input signal from an audio source;
A first analog-to-digital converter of the first analog input signal to produce a second digital signal;
At least one first digital component for performing a first digital equalization of the second digital signal, said first digital equalization being configurable according to input parameters, to produce a third digital signal;
A first digital-to-analog converter of the third digital signal to generate a fourth analog signal;
An analog processing stage comprising at least one electronic component having at least one predefined non-linear operating range, said stage being configured to process the fourth analog signal in at least a part of the non-linear operating range in order to generate a fifth analog signal;
A second analog-to-digital converter of the fifth analog signal to produce a sixth digital signal;
At least one second digital component for performing a second digital equalization of said sixth digital signal, said second digital equalization being configurable according to second input parameters, to produce a seventh digital signal.

The device for processing an audio signal according to the invention makes it possible to benefit from the advantages of analog processing devices and the advantages of digital processing devices. It has been observed that numerical simulations of components having non-linear behavior were difficult to perform in a faithful manner, leading to non-fidelity of the simulations. The device according to the invention makes it possible to overcome these drawbacks, because it makes it possible to use at least one analog component in a non-linearity zone. As a result, the parts of the processing of the audio signal (such as equalizations, amplifications) that can be easily and faithfully modeled are realized by the first digital component and/or the second digital component. In contrast, the non-linearities of the signal are generated in the analog processing stage by the at least one electronic component. Thus, non-linearities are available in the signal that are specific to analog components. Similarly, the power and adaptability of digital components are available to perform equalization and amplification operations. It may also be noted that the equalization operations practiced on the digital signal are much lighter in resources than simulation operations carried out by the digital systems of the prior art. They therefore require digital signal processors consuming less energy and being less expensive than those of the prior art. The processing device according to the invention makes it possible to reproduce the nuances and dynamics of a fully analog effect while having the versatility and the possibilities of memorization of a digital effect. The digital control of the equalization operations, notably the first digital equalization operation, also allows the behavior of the analog processing stage to be controlled, which makes it possible to obtain audio signal processing possibilities that are not accessible by a fully analog device or by a fully digital device.

According to one embodiment, the device for processing an audio signal further comprises:
A second digital-to-analog converter of the seventh digital output signal to produce an eighth analog signal; and
An output interface of the eighth analog output signal at the output of the first digital component.

This arrangement makes it possible to have an analog output of the signal and thus to insert the processing device into a fully digital signal chain.

According to one embodiment, at least one electronic component having at least one predefined non-linear operating range of the analog processing stage is a diode, a transistor, an optocoupler, or an amplification valve. Such components make it possible to perform functions of amplification, clipping, compression or modulation of the signal in the analog processing stage.

According to one embodiment, the first digital component and/or the second digital component is configured to adjust the bias of the electronic component having at least one predefined non-linear operating range. These characteristics allow an adaptation of the bias due to the at least one electronic component having a predefined non-linear operating range by the digital component(s). In this way, operating points for these components may be easily chosen and easily adapted, either statically or dynamically.

According to one embodiment, the device for processing an audio signal comprises at least one control digital-to-analog converter configured to provide at least one control analog signal adjusting the bias of the electronic component having at least one predefined non-linear operating range as a function of a first control datum provided by the first digital component and/or as a function of a second control datum provided by the second digital component. According to this arrangement, the bias is set as a function of a control datum that may be set by a user or generated as a function of other data that may be memorized, measured and/or calculated.

According to one embodiment, the first digital component comprises an analysis stage of the second digital signal, said analysis stage being configured to generate the first control datum as a function at least one measured characteristic of a second digital signal. This characteristic makes it possible to carry out the control of the bias of the component(s) of the analog processing stage as a function of measured data of the signal at the input of the device for processing an audio signal. In this way, the signal processing may be varied as a function of the playing dynamics of a musician.

According to one embodiment, the second digital component comprises an analysis stage of the sixth digital signal, said analysis stage being configured to generate the second control datum as a function of at least one measured characteristic of the sixth digital signal. According to this arrangement, the bias is adapted as a function of characteristics measured on the output signal of the analog processing stage. In this way, the processing by the analog processing stage may be carried out as a function of the response of said stage.

According to one embodiment, the first control datum comprises an envelope detection datum of the second digital signal and/or a datum generated as a function of a harmonic analysis of the second signal and/or an amplitude datum of the second digital signal. These arrangements make it possible to carry out a compression to vary the analog processing of the signal as a function of the amplitude thereof, the detection of its envelope or the frequency characteristics thereof. In this way, the processing is adapted as a function of the playing dynamics of the musician, or as a function of the frequency characteristics of the signal coming from his instrument.

According to one embodiment, the second control datum comprises an envelope detection datum of the sixth digital signal and/or a datum generated as a function of a harmonic analysis of the sixth signal and/or an amplitude datum of the sixth digital signal. In this way, the processing is adapted as a function of the playing dynamics of the musician, or as a function of the frequency characteristics of the signal coming from his instrument, after processing by the analog processing stage. The processing of the signal is therefore adapted to the musician's play, to the characteristics of his instrument, and to the response of the analog processing stage to this signal.

According to one embodiment, the device for processing an audio signal comprises a temperature sensor and/or a luminosity sensor and/or a hygrometry sensor. This arrangement makes it possible to measure parameters that are able to influence the operation of electronic components.

According to one embodiment, the first control datum and/or the second control datum is generated as a function of a parameter measured by the temperature sensor and/or a luminosity sensor and/or a hygrometry sensor. This characteristic makes it possible to change the operating point of the electronic component(s) having at least one predefined non-linear operating zone as a function of environmental parameters that may influence it. In this way, it is possible to maintain a stable operation of said components even when these parameters vary.

According to one embodiment, the first digital component is configured to perform a frequency filtering and/or an amplification of the second digital signal. This arrangement makes it possible to change the characteristics of the signal before passing through the analog processing stage and will therefore influence the quality of the analog processing. In addition, the fact that this processing is done digitally allows for a high degree of adaptability of this processing and a change thereof without having to change components.

According to one embodiment, the second digital component is configured to perform a frequency filtering and/or an amplification of the sixth digital signal. This arrangement allows a filtering and a processing of the signal that is going to come out of the processing device with great adaptability of the latter without having to change components.

According to one embodiment, the first digital component is configured to transmit a third derived digital signal to the second digital component that is configured to mix the third derived digital signal with the sixth digital signal. This arrangement makes it possible to perform a soft clipping of the signal, which is fully parameterizable thanks to the first digital equalization and the second digital equalization.

The invention also relates to an audio processing unit for musical instrument comprising a processing device according to the invention, said audio processing unit comprising a switch commanding the activation of the processing device, at least one first actuator for configuring the first input parameters and/or the second input parameters and/or the bias. In this way, an audio processing unit is available benefiting from the advantages of the processing device according to the invention, which may be actuated by the user and the parameters of which may be set by the user.

According to one embodiment, the audio processing unit comprises an electronic component and a memory, said memory recording a plurality of operating configurations of ranges of values of the first input parameters with the second input parameters and with the bias values, the at least first actuator comprising actuatable positions making it possible to select a given configuration recorded in the memory, said selection automatically configuring the processing device. The presence of the memory allows a memorization of parameters corresponding to a configuration entered by a user. In this way, the user can find configurations that he appreciates.

According to one embodiment, the audio processing unit is an effect pedal for electric instrument, an amplifier for electric instrument, a rack type unit for electric instrument, or a mixing table.

The invention also relates to a method for processing an audio signal that comprises the steps of:
An acquisition of a first analog input signal from a musical instrument/voice;
A first analog-to-digital conversion of the first analog input signal to produce a second digital signal;
At least one first equalization of the second digital signal by a first digital component, said first digital equalization being configurable according to first input parameters, to produce a third digital signal;
A first digital-to-analog conversion of the third digital signal to generate a fourth analog signal;
An analog processing, by an analog processing stage comprising at least one electronic component having at least one predefined non-linear operating range, of the fourth analog signal in at least a part of the non-linear operating range in order to generate a fifth analog signal;
A second analog-to-digital conversion of the fifth analog signal to produce a sixth digital signal;
A second digital equalization of the sixth digital signal by at least one second digital component, said second digital equalization being configurable according to second input parameters, to produce a seventh digital signal;
A second digital-to-analog conversion of the seventh digital output signal to produce an eighth analog signal; and
An output of the eighth analog signal via an output interface.

### BRIEF DESCRIPTION OF THE FIGURES

Other characteristics and advantages of the invention will become clearer upon reading the following detailed description, in reference to the appended figures, that illustrate:

FIG. 1: a block diagram of a device for processing an audio signal according to a first embodiment of the invention;

FIG. 2: a block diagram of a device for processing an audio signal according to a second embodiment of the invention;

FIG. 3: an electrical diagram of an analog processing stage of a device for processing an audio signal according to a third embodiment of the invention;

FIG. 4: an electrical diagram of an analog processing stage of a device for processing an audio signal according to a fourth embodiment of the invention;

FIG. 5: an electrical diagram of an analog processing stage of a device for processing an audio signal according to a fifth embodiment of the invention; and

FIG. 6: a view of a device for processing an audio signal in use according to a sixth embodiment of the invention.

### DESCRIPTION OF THE INVENTION

FIG. 1 represents a block diagram of a first embodiment of a device for processing DIS1 an audio signal S1 according to a first embodiment of the invention. In this diagram, each block represents a functional and/or hardware block of the processing device DIS1.

The processing device DIS1 comprises an acquisition interface INT1 of an analog signal S1. The first analog signal S1 is an audio signal. Audio signal S1 is taken to mean an electrical signal that is coming from an audio source. Said audio source may for example be an electroacoustic musical instrument, instrument that comprises at least one microphone transforming a sound wave into an electrical signal S1. The audio source may also be an electronic musical instrument that produces an electrical signal S1. The audio source may also be a microphone picking up the sound of a voice or an acoustic musical instrument. The audio source may also be an electrical signal coming from an electronic sound processing unit. According to one embodiment, the audio source is an electric guitar or an electric bass.

The acquisition interface INT1 is for example a plug for connecting a connection cable to a musical instrument. This acquisition interface INT1 makes it possible to collect the electrical signal from the audio source.

The processing device DIS1 next comprises a first analog-to-digital converter CAN1. The first analog-to-digital converter CAN1 converts the analog input signal S1 to produce a second digital signal S2.

The processing device DIS1 next comprises at least one first digital component NUM1. The first digital component NUM1 receives the second digital signal S2.

The first digital component is configured to perform a first digital equalization EGAL1 of the second digital signal S2. First digital equalization EGAL1 is taken to mean at least one digital equalization of the second signal, or two, three or four successive equalizations of the digital signal. The first digital equalization EGAL1 of the second signal may be a frequency equalization thereof. It may also be an amplification of said second digital signal S2. The first digital equalization EGAL1 may also be a succession of several frequency equalizations and/or several amplifications of the signal. According to one embodiment, the digital equalization of the second signal comprises a frequency equalization and an amplification of said second signal S2. According to one embodiment, the first digital equalization comprises, in addition to or in lieu of the frequency equalization, a digital dynamic processing of the signal. For example, this dynamic processing may be a digital compression of the signal. The first digital equalization EGAL1 of the second signal S2 produces a third digital signal S3. The first digital equalization EGAL1 is configurable according to first input parameters PARA1. The first input parameters PARA1 make it possible to select the type of equalization performed. They also make it possible to select the frequency bands that will be amplified or attenuated by a frequency equalization. They also make it possible to select a digital dynamic processing of the signal, for example a digital compression of the signal.

The processing device DIS1 next comprises a first digital-to-analog converter CNA1. The first digital-to-analog converter CNA1 is configured to convert the third digital signal S3 into a fourth analog signal S4. The conversion of the third digital signal S3 is particularly advantageous because it allows a fourth analog signal to be sent, which can be analogically processed.

The processing device DIS1 next comprises an analog processing stage ANA1. The analog processing stage is configured to receive an analog input signal. The analog processing stage ANA1 receives the fourth analog signal S4 to perform an analog processing thereof. The analog processing stage ANA1 comprises an electronic component having at least one predefined non-linear operating range. Predefined non-linear operating range is taken to mean an operating range in which the electronic component behaves non-linearly with respect to the analog signal calling upon it. The analog processing stage is configured to process the fourth analog signal S4 in at least a part of the non-linear operating range. The analog processing stage therefore processes the fourth analog signal S4 in the non-linear operating range of the electronic component. In this way, the electronic component introduces non-linearities into the fourth analog signal S4. These non-linearities are therefore introduced into the analog signal by an analog component. This arrangement makes it possible to maintain the acoustic quality of the non-linearities introduced analogously into the signal. This is particularly advantageous because it is very difficult to faithfully model the non-linear operation of an analog component digitally. The analog processing stage ANA1 generates a fifth analog signal S5 which is derived from the analog processing of the fourth analog signal S4. The digital control of the second digital equalization operation NUM1 also makes it possible to control the behavior of the analog processing stage. Notably, it makes it possible to fix operating points thereof. This makes it possible to obtain audio signal processing possibilities that are not accessible by a fully analog device or a fully digital device.

The processing device DIS1 next comprises a second analog-to-digital converter CAN2. The second analog-to-digital converter CAN2 is configured to convert the fifth analog signal S5 to a sixth digital signal S6. The conversion enables a digital processing of the sixth digital signal S6.

The processing device DIS1 next comprises a second digital component NUM2. The second digital component NUM2 is configured to perform at least one second equalization EGAL2 of the sixth digital signal S6. Second digital equalization EGAL2 is taken to mean at least one digital equalization of the sixth digital signal S6, or two, three or four successive equalizations of the sixth digital signal S6. The second digital equalization EGAL2 of the sixth digital signal S6 may be a frequency equalization thereof. It may also be an amplification of said sixth digital signal S6. The second digital equalization EGAL2 may also be a succession of several frequency equalizations and/or several signal amplifications. According to one embodiment, the second digital equalization EGAL2 of the sixth digital signal S6 comprises a frequency equalization of said sixth signal S6. The second digital equalization EGAL2 of the sixth signal S6 produces a seventh digital signal S7. The second digital equalization EGAL2 is configurable according to second input parameters PARA2. The second input parameters PARA2 make it possible to select the type of equalization performed. They also make it possible to select the frequency bands that will be amplified or attenuated by a frequency equalization.

The processing device DIS1 according to the invention therefore advantageously makes it possible to produce a seventh digital signal S7 from the analog input signal S1. The advantage of the device according to the invention is to enable digital signal processing upstream and downstream of the analog processing stage ANA1. In this way, the operations of equalization and amplification of the signal are performed digitally, allowing the benefits of digital technologies in these areas to be taken advantage of in terms of parameterization, interaction with other devices, device compactness and adaptability. It is notably possible to adapt the different equalizations without having to change the components of the equalization stages of the analog devices. Thus, a same device may have different equalizations possible by settings of the first input parameter PARA1 and the second input parameter PARA2, such equalizations being impossible to obtain in an analog device without having to change components. The device according to the invention also makes it possible to have fidelity in the non-linear behavior of the analog components that it comprises. Such behaviors are very difficult to model digitally. Thus, the device according to the invention makes it possible to retain the sound quality of analog devices by retaining an analog component while benefiting from the advantages of digital devices.

According to one embodiment, the processing device DIS1 comprises a second digital-to-analog converter CNA2. The second digital-to-analog converter is configured to convert the seventh digital signal S7 into an eighth analog signal S8.

The processing device DIS1 next comprises an output interface INT2. The output interface INT2 makes it possible to make an output interface of the eighth analog signal S8. The output interface S8 may be for example a jack connector, a mini-jack connector, or any other type of connector.

The analog conversion of the seventh digital signal S6 into an eighth analog signal S8 advantageously makes it possible to have a processing device DIS1 which takes at input a first analog signal S1 and at output an eighth analog signal S8. In this way, the processing device DIS1 may be inserted into an analog audio signal chain.

According to one embodiment, the processing device DIS1 comprises between the acquisition interface INT1 and the first analog digital converter CAN1 an adjustment stage of the input signal. The adjustment stage of the input signal is configured to adjust the level of the first analog input signal. This adjustment is carried out by applying a gain to the first analog signal S1. This arrangement makes it possible to adjust the level in order to maximize the efficiency of the analog-to-digital conversion of the first analog-to-digital converter CAN1 and to avoid saturation of it.

According to one embodiment, the acquisition interface INT1 comprises a signal shunt element making it possible to transmit the first analog input signal S1 directly to the output interface INT2. This arrangement makes it possible to have for the device an operating mode in which the first analog input signal S1 is transmitted directly to the output of the analog processing device DIS1. When the shunt element is activated, the signal no longer passes through the converter and the analog processing stage ANA1. Thus, the device has a mode in which the signal passes through it without being processed. In this way, the processing device may be inserted into an audio signal processing chain and be activated to process the signal or not. The shunt element may be a switch.

According to one embodiment, the first digital component NUM1 and the second digital component NUM2 are part of the same data processing processor. According to this embodiment, the functions ensured by the first digital component NUM1 and the second digital component NUM2 are performed by the processing processor. This arrangement makes it possible to combine the functions in a single component and thus to save electrical energy and to lower production costs.

### Analog Processing Stage

According to one embodiment, at least one of the electronic components having at least one predefined non-linear operating range COMP1 of the analog processing stage ANA1 is a diode. Any type of diode may be provided in this stage.

According to one embodiment, at least one of the electronic components having at least one predefined non-linear operating range COMP1 of the analog processing stage ANA1 is a transistor. Any type of transistor may be provided in this stage, for example a bipolar transistor (or BJET), a field effect transistor (or FET), an insulated grid field effect transistor (or MOSFET).

According to one embodiment, at least one of the electronic components having at least one predefined non-linear operating range COMP1 of the analog processing stage ANA1 is an optocoupler.

According to one embodiment, at least one of the electronic components having at least one predefined non-linear operating range COMP1 of the analog processing stage ANA1 is an amplification valve or vacuum tube such as triodes or pentodes for example.

According to one embodiment, at least one of the electronic components having at least one predefined non-linear operating range COMP1 of the analog processing stage ANA1 is a complex circuit. An example of a complex circuit is an operational amplifier.

As described previously, the analog processing stage ANA1 comprises at least one electronic component COMP1 comprising at least one non-linear operating range. Predefined non-linear operating range is taken to mean an operating range of the component in which the component does not behave linearly. This predefined zone corresponds to a specific range of voltage applied to terminals of the electronic component, and/or a specific zone of amperage passing through said component, or any specific zone of electronic operation of said component. For example, in the case of a diode, the predefined non-linear behavior zone relates more particularly to the zone in which the electrical voltage at the terminals of the diode is close to the threshold voltage of the diode. In this zone, the diode has a non-linear behavior that is difficult to model in an extremely faithful manner.

According to one embodiment, the first digital component is configured to adjust the bias BIAS1 of the at least one electronic component COMP1 having a predefined non-linear operating range. To adjust the bias BIAS1, the first component COMP1 is configured to adjust the electrical potential at a terminal of said component COMP1. This voltage adjustment makes it possible to adjust the predefined non-linear operating range. Bias is taken to mean a deliberate shift of an electrical or magnetic quantity in the analog circuit, such as a current or polarization voltage of the component. According to one example, bias setting or bias adjustment is taken to mean the setting or the adjustment of the polarization voltage of a transistor, a diode and/or an amplification valve. In this way, the entry of the component into its predefined zone of non-linear operation is controlled. Thus, the harmonic characteristics of the signal at the output of the analog processing stage are controlled.

The analog processing stage is configured to process the fourth analog signal S4 in at least a part of the predefined non-linear operating range of the at least one electronic component COMP1. This means that the analog processing stage ANA1 is configured such that the electrical current passing through the at least one electronic component COMP1 and/or the electrical voltage at its terminals reaches the predefined non-linear operating range.

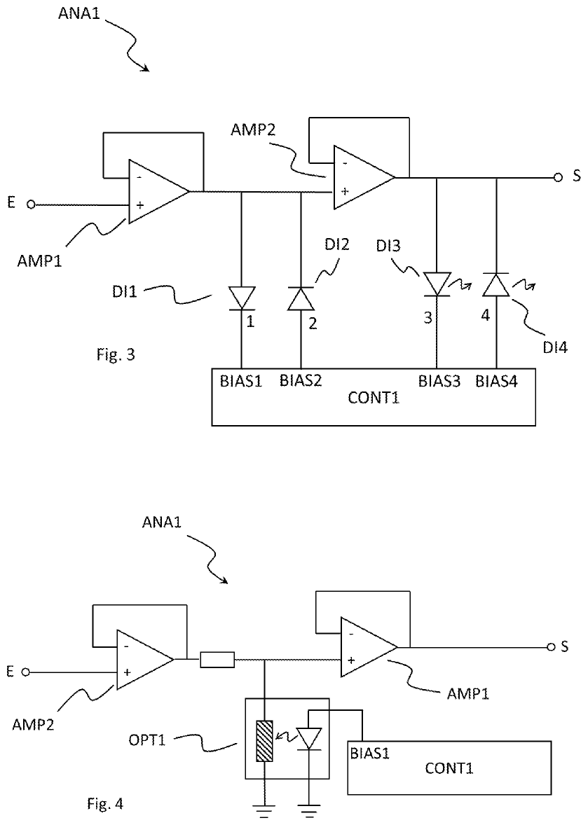

According to one embodiment, the analog processing stage ANA1 comprises at least two electronic components having at least one predefined non-linear operating range that are called upon in their predefined non-linear operating range. For example, the analog processing stage ANA1 comprises two clipping diodes connected in reverse and in shunt. A processing device DIS1 comprising two diodes is shown in FIG. 3. According to this embodiment, the processing device DIS1 also comprises two light emitting diodes.

According to one embodiment, the processing device DIS1 comprises at least one control digital-to-analog converter CONT1. The control digital-to-analog converter is configured to convert a first control digital datum D1 from the first digital component NUM1 and/or a second control digital datum D2 from the second digital component NUM2 into a control analog signal. The control analog signal is advantageously a voltage adjustment of the bias BIAS1. Such an arrangement represents a practical means of controlling the bias by the first digital component NUM1 and/or by the second digital component NUM2. The control digital-to-analog converter CONT1 is a converter that requires less power than the other converters of the processing device DIS1 because it does not directly convert a sound signal. In this way, the control digital-to-analog converter CONT1 may be a PWM (Pulse Width Modulation) controller. Such a module consumes less energy and is cheaper than a digital-to-analog converter to convert an audio signal.

According to one embodiment, the analog processing stage ANA1 comprises three electronic components having at least one predefined non-linear operating range COMP1 that are called upon in their predefined non-linear operating range. According to another embodiment, it comprises four, five, six, seven, eight or nine thereof.

According to one embodiment, the first digital component NUM1 is configured to independently adjust the bias of two or more components having a predefined non-linear operating range COMP1. In this case, the first digital component provides several first control digital data D1 to the control digital-to-analog converter CNA3 which converts them into several control analog signals. In this way, the first digital component NUM1 can simultaneously digitally control several biases of several electronic components of the analog processing stage ANA1.

According to one embodiment, the second digital component NUM2 is configured to independently adjust the bias of two or more components having a predefined non-linear operating range COMP1. In this case, the second digital component provides several second control digital data D2 to the control digital-to-analog converter CNA3 which converts them into several control analog signals. In this way, the second digital component NUM2 can simultaneously control several biases of several electronic components of the analog processing stage ANA1.

According to one embodiment, the first and second digital components both provide control digital data D1, D2 to the control digital-to-analog converter CNA3. These are converted into control analog signals to adjust the bias(s) of several analog components of the analog processing stage.

It may be noted that the fact of using digital equalizations and a digital control of components having at least one non-linear operating range COMP1 makes it possible to use any type of diode in the analog processing stage ANA1. Thus, it is possible with a common diode to simulate the operation of a less common diode. In this way, diodes that are easier to obtain and less expensive can be placed in the analog processing stage ANA1.

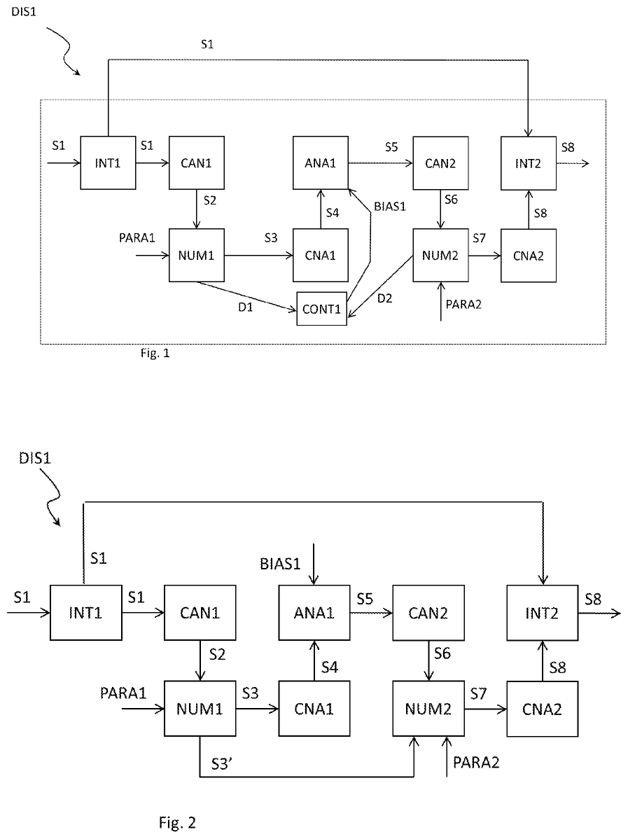

According to one embodiment, the first digital component NUM1 is configured to transmit a third derived digital signal S3′ to the second digital component NUM2. According to this embodiment, the second digital component NUM2 is configured to mix the third derived digital signal S3′ with the sixth digital signal S6. This arrangement makes it possible to implement a soft clipping as opposed to a hard clipping. This arrangement is notably shown in FIG. 2.

Notably, the fact of having the derived digital signal S3′ that will be mixed with the output signal of the analog processing stage ANA1 makes it possible to have a circuit in which the gain can be memorized easily in the processing device DIS1. Indeed, the gain in the processing device is generated digitally, resulting in advantages in terms of its memorization and control.

### Bias Control Modalities

Below we will describe several modalities for controlling the bias. In those described below, bias is taken to mean one of the multiple biases or all the biases that are adjustable in the analog processing stage ANA1.

According to one embodiment, the bias is adjustable within a fixed control range. In this way, a bias corresponding to one or more predefined operating points of the analog processing stage ANA1 is fixed. In this way, the analog processing stage ANA1 can be operated according to several operating points that would not be attainable by a fully analog processing device.

According to one embodiment, the bias value(s) are selected by browsing between several predefined operating points. In this way, a musician setting the processing device DIS1 according to the invention can browse between several operating points making it possible to obtain a mastered sound result. In this way, the use of the processing device DIS1 is very intuitive for the musician.

According to one embodiment, the bias value(s) corresponding to the different operating points are calculated by prior simulation of the analog operating stage ANA1. The simulation is carried out by measuring the harmonics generated by the analog processing in the output signal of the analog processing stage ANA1. This mode of searching for operating points makes it possible to find operating points enabling the generation of an output signal with unique harmonic characteristics.

According to one embodiment, the first digital component NUM1 comprises an analysis stage of the second digital signal S2. This analysis stage is configured to measure characteristic data of the second digital signal S2. The analysis stage may for example perform an envelope detection on the second digital signal S2. It may also measure an amplitude of said signal. It may also measure characteristic data of the harmonic characteristics of the second digital signal S2.

According to one embodiment, the first digital component adapts the bias as a function of the characteristic data measured on the second digital signal S2. This arrangement makes it possible to adapt the bias dynamically as a function of characteristics of the measured signal and therefore to have a control of the processing carried out by the analog processing stage ANA1 as a function of the measured signal characteristics.

According to one embodiment, the second digital component adapts the bias as a function of the characteristic datum or data measured on the sixth digital signal S6. This arrangement makes it possible to adapt the bias dynamically as a function of characteristics of the measured signal and therefore to have a control of the processing carried out by the analog processing stage ANA1 as a function of the measured signal characteristics.

According to one embodiment, the bias(es) are adapted as a function of characteristics measured on the second digital signal S2 and as a function of characteristics measured on the sixth digital signal S6.

According to one embodiment, the first control datum D1 and/or the second control datum D2 are generated as a function of the characteristic(s) measured by the analysis stage of the first digital component NUM1. According to one embodiment, the first control datum D1 and/or the second control datum D2 are generated as a function of the characteristic(s) measured by the analysis stage of the second digital component NUM2.

According to one embodiment, the processing device DIS1 comprises at least one adjustment sensor CAPT. The adjustment sensor is configured to measure a physical datum related to the environment of the processing device DIS1.

According to one embodiment, the first control datum and/or the second control datum are generated as a function of the datum measured by the adjustment sensor CAPT. According to this embodiment, the bias is therefore adjusted as a function of the datum measured by the adjustment sensor CAPT. The behavior of electronic components is often disrupted by the surrounding physical conditions. In this way, the bias is adjusted as a function of the measurement of these data in order for example that the electronic component of which the bias is regulated is the same regardless of the environmental conditions.

According to one embodiment, the adjustment sensor is a temperature sensor. Temperature is a physical datum disrupting the behavior of certain electronic components. Notably, the operation of some types of diodes is greatly disrupted by temperature changes shifting some of their characteristic operating points. In this way, the bias is adapted in order to maintain equal operation when temperature conditions happen to change.

According to one embodiment, the adjustment sensor is a luminosity sensor. The adjustment sensor measures the ambient luminosity in the vicinity of the processing device DIS1. In this way, the operating points of some of the components of the analog processing stage ANA1 can be modified as a function of the ambient luminosity. This arrangement advantageously makes it possible to have a processing device DIS1 that reacts as a function of the external light environment. This is particularly advantageous because this mode of operation allows the musician to have a creative approach that allows him to seek out new sound qualities. In addition, in the context of improvisation for example, the result is more interesting for the listener because the sound processing evolves with the environment.

According to one embodiment, the adjustment sensor is a hygrometry sensor. According to this embodiment, the sensor measures the ambient humidity in the vicinity of the processing device DIS1. Humidity is a physical datum disrupting the behavior of certain electronic components. In this way, the bias is adapted in order to maintain equal operation when temperature conditions happen to change.

According to one embodiment, the adjustment sensor is a heart rate sensor. In this way, the signal processing can change as a function of the musician's state, notably his pulse. According to one embodiment, the adjustment sensor is a blood pressure sensor.

According to one embodiment, the adjustment sensor is one or more accelerometers. In this way, the signal processing can change as a function of the movement of the processing device DIS1. According to this embodiment, the musician can influence the processing of the signal, for example by moving the processing device with his foot. According to one embodiment, at least one accelerometer is arranged on the musician. In this way, the musician can influence the operation of the processing device DIS1 by movements of his body.

According to one embodiment, the bias is adjusted as a function of an analysis of the second digital signal S2 and/or the sixth digital signal S6 as described above and as a function of a datum measured by the adjustment sensor CAPT as described above. In this way, the adjustment of the bias or biases of the components of the analog processing stage ANA1 is made as a function of both the analysis of the signal and the measurement of the conditions surrounding the processing device DIS1.

### Digital Equalizations

According to one embodiment, the first digital equalization EGAL1 comprises a first filtering step. Advantageously, this first filtering step comprises the use of a high-pass filter. Advantageously, this high-pass filter is a second-order filter making it possible to filter out high-frequency interference noise. Advantageously, this first filtering step comprises the use of a low-pass filter. Advantageously, the low-pass filter is a first-order low-pass filter. This arrangement makes it possible to attenuate the high harmonics of the instrument connected to the processing device DIS1. This simulates the influence on the microphone of a connected instrument of the variable input impedance of an analog processing device. Advantageously, this first filtering step comprises the use of a high shelf equalization filter. Such a filtering makes it possible to simulate a variable input impedance of the processing device DIS1. Advantageously, this first filtering step comprises the use of a two-band parametric equalization. Each parameter of each of the filterings can be adapted by setting the first digital component NUM1.

According to one embodiment, the first digital equalization next comprises a preparatory frequency equalization step upon arrival in the analog processing stage ANA1. This equalization advantageously makes it possible to select signal bands and amplify them before sending them to the analog processing stage ANA1. For example, it is possible to amplify the medium frequencies of the signal before sending into the analog processing stage ANA1. The same operation may be performed with the low frequencies and/or with the high frequencies of the signal. For example, in the case where it could be wished to overdrive the signal with the processing device DIS1, it is possible to carry out at this stage an amplification of the medium frequencies of the signal before sending the signal into an analog processing stage ANA1 comprising a diode clipping circuit. In this way, a saturation is performed on the signal preferably on the frequencies that have been amplified, namely the medium frequencies. This type of processing is particularly sought after by musicians. According to one embodiment, the first digital equalization next comprises a step of preparatory amplification upon arrival in the analog processing stage ANA1. This arrangement makes it possible to set the signal level in order to influence the processing in the analog processing stage ANA1. For example, in the case where the analog processing stage comprises a diode clipping circuit, the setting of the amplification level (also called gain) makes it possible to set the saturation rate in the analog processing stage. According to one embodiment, the first digital equalization next comprises a digital clipping stage of the signal. This arrangement makes it possible to have a third digital signal S3 at the output of the first digital component NUM1 in the level that does not exceed the saturation level of the first digital-to-analog converter CNA1. In this way, saturation of the converter CNA1 is avoided.

According to one embodiment, and when the first digital component NUM1 transmits a third derived digital signal S3′ to the second digital component NUM2, the derived digital signal may have undergone only part of the first digital equalization EGAL1 before being sent to the second digital component NUM2. According to one embodiment, the third derived digital signal S3′ is a copy of the output signal of the first filtering step of the first digital equalization EGAL1. In this way, the third derived digital signal S3′ is a signal that has not undergone the steps of the first digital equalization that are performed to prepare the signal for its entry into the analog processing stage ANA1.

According to one embodiment, the third derived digital signal undergoes an amplification step before it arrives in the second digital component NUM2. This step notably makes it possible to equalize the levels between the signal that has passed through the analog processing stage ANA1 and the third derived digital signal S3′.

According to one embodiment, the third derived digital signal also undergoes a frequency equalization prior to its arrival in the second digital component NUM2. This step allows a frequency setting of the third derived digital signal.

According to one embodiment, the third derived digital signal is delayed in time in order to compensate for the processing time of the signal passing through the analog processing stage ANA1 (and thus through the first digital-to-analog converter CNA1 and the second analog converter CAN2). This arrangement makes it possible to avoid phase problems of the two different signal paths taken before their mixing in the second digital component NUM2. In this way, the third derived digital signal S3′ and the sixth digital signal S6 are well in phase before the mixing thereof.

According to one embodiment, the first equalization is parameterizable according to an input parameter PARA1. The input parameter advantageously comprises a set of data comprising the parameter of each filter implemented in the first equalization. Each parameter of the different processings performed on the third derived digital signal S3′ before its mixing in the second digital component NUM2 is also parameterizable by the first input parameter PARA1. Each datum of the data set of the input parameter PARA1 is advantageously calculated from one or more parameters provided by the user. This arrangement makes it possible to parameterize several advantageous operating points giving the best sound results for the user without the user having to enter each parameter of the first equalization EGAL1. According to one embodiment, each parameter of the first equalization may be individually set by the user.

According to one embodiment, the second digital equalization EGAL2 comprises a step of frequency equalization of the sixth digital signal S6. This equalization allows the digitized signal coming from the analog processing stage ANA1 to be processed in a frequency-based manner. When the digital signal is mixed with the third derived digital signal S3′, the frequency equalization step is performed before the mixing of the two signals.

According to one embodiment, the second equalization EGAL2 comprises a step of amplification or attenuation of the sixth digital signal S6. When the digital signal is mixed with the third derived digital signal S3′, the amplification or attenuation step is performed after mixing the two signals.

According to one embodiment, the second equalization comprises an output frequency equalization step. This step is a frequency equalization to produce the seventh signal S7. When the digital signal is mixed with the third derived digital signal S3′, this output frequency equalization step is performed after mixing this signal with the sixth digital signal S6.

### Examples of Analog Processing Stages

As an example, we will describe several architectures that may be implemented in the analog processing stage ANA1.

A first embodiment of the analog processing stage ANA1 is described in support of FIG. 3. This analog processing stage ANA1 comprises a diode clipping circuit. This analog processing stage ANA1 comprises two clipping diodes DI1, DI2. It also comprises two light emitting diodes DI3, DI4. In this, the electronic components having at least one predefined non-linear operating range and that will be called upon in this predefined non-linear operating range are the clipping diodes DI1, DI2 and the light-emitting diodes DI3, DI4. The two operational amplifiers AMP1, AMP2 are here only used in their linear operating range. This analog processing stage ANA1 allows a diode clipping to be performed on the fourth analog signal S4. The diodes used in this stage may be silicon diodes or germanium diodes.

The analog processing stage ANA1 comprises an input terminal E through which enters the fourth analog signal S4 and an output terminal S through which exits the fifth analog signal S5.

In this analog processing stage ANA1, the four diodes DI1, DI2, DI3, DI4 are connected at one of their terminals 1, 2, 3, 4 to one or more bias control devices. According to one embodiment, the terminals 1, 2, 3, 4 are connected to the control digital-to-analog converter CNA3. In this way, the control digital-to-analog converter CNA3 controls the electrical potential at the terminal of each diode DI1, DI2, DI3, DI4 in order to control their bias. According to one arrangement, each diode may have the same bias setting. According to another arrangement, each bias BIAS1, BIAS2, BIAS3, BIAS4 may be independently controlled by the control digital-to-analog converter CNA3. The control digital-to-analog converter CNA3 generates the different biases as a function of the first digital datum D1 and/or the second digital datum D2. Each bias may be set statically, or dynamically as a function of data measured on the signal in the first digital component NUM1 and second digital component NUM2, or periodically, according to a frequency which is in the order of magnitude of the frequencies of the processed audio signal or which is a much lower frequency. In this case, the use of the analog processing stage ANA1 makes it possible to retain the sound character provided by the use of the analog diodes DI1, DI2, DI3, DI4 while having the qualities of digital equalizations, as well as the tools for analyzing signals and adapting the biases BIAS1, BIAS2, BIAS3, BIAS4 as a function of these analyses.

A second embodiment of the analog processing stage ANA1 is described in support of FIG. 4. This analog processing stage ANA1 comprises a circuit for modulating the amplitude of the signal passing through it. This analog processing stage ANA1 comprises an optocoupler or optical coupler OPT1. In this, the electronic component having at least one predefined non-linear operating range and which will be called upon in this predefined non-linear operating range is the optocoupler OPT1. The two operational amplifiers AMP1, AMP2 are here only used in their linear operating range. This analog processing stage ANA1 allows an amplitude modulation to be performed on the fourth analog signal S4.

The analog processing stage ANA1 comprises an input terminal E through which enters the fourth analog signal S4 and an output terminal S through which exits the fifth analog signal S5.

In this analog processing stage ANA1, the optocoupler OPT1 is connected at one of its terminals 1 to a bias control device. According to one embodiment, the terminal 1 is connected to the control digital-to-analog converter CNA3. In this way, the control digital-to-analog converter CNA3 controls the electrical potential at the terminal 1 in order to control the bias thereof. The control digital-to-analog converter CNA3 generates the bias as a function of the first digital datum D1 and/or the second digital datum D2. The bias may be set statically, or dynamically as a function of data measured on the signal in the first digital component NUM1 and second digital component NUM2, or periodically, according to a frequency which is in the order of magnitude of the frequencies of the processed audio signal or which is a much lower frequency. According to a preferred embodiment, the bias is periodically controlled so as to adjust the amplitude of the fifth analog signal and thereby create a tremolo effect thereon. According to one alternative, the bias is controlled as a function of amplitude data measured on the second digital signal S2 in order to modulate the amplitude of the signal. In this case, the processing device DIS1 performs a sound compression function, for example by decreasing the amplitude of the high amplitude zones of the signal. In this case, the use of the analog processing stage ANA1 makes it possible to maintain the sound character provided by the use of the analog optocoupler while having the qualities of digital equalizations, as well as the tools for analyzing signals and adapting the bias as a function of these analyses.

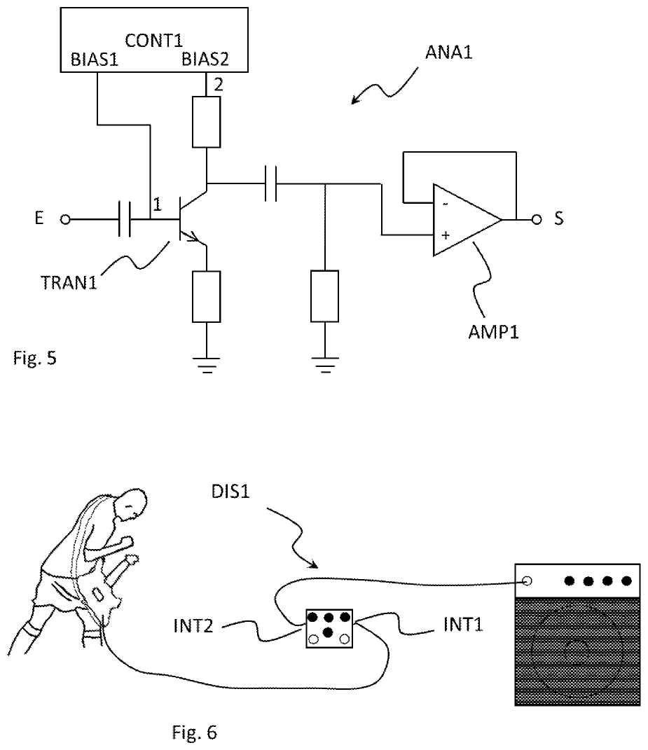

A third embodiment of the analog processing stage ANA1 is described in support of FIG. 5. This analog processing stage ANA1 comprises a circuit for amplifying the signal passing through it. This analog processing stage ANA1 comprises a transistor TRAN1. In this, the electronic component having at least one predefined non-linear operating range and which will be called upon in this predefined non-linear operating range is the transistor TRAN1. The operational amplifier AMP1 is only called upon in its linear operating range. This analog processing stage ANA1 makes it possible to perform a transistor amplification and a transistor-based clipping on the fourth analog signal S4.

The analog processing stage ANA1 comprises an input terminal E through which enters the fourth analog signal S4 and an output terminal S through which exits the fifth analog signal S5.

In this analog processing stage ANA1, the transistor TRAN1 is connected at one of its terminals 1 to a bias control device. The transistor TRAN1 is connected at another of its terminals to a resistor itself connected at one terminal 2 to the bias control device. According to one embodiment, the terminals 1, 2 are connected to the control digital-to-analog converter CNA3. In this way, the control digital-to-analog converter CNA3 controls the electrical potential at the terminals 1, 2 in order to control the bias BIAS1 of the terminal 1 and the bias BIAS2 of the second terminal 2 thereof. The control digital-to-analog converter CNA3 generates the bias BIAS1, BIAS2 as a function of the first digital datum D1 and/or the second digital datum D2. The biases BIAS1, BIAS2 may be set statically, or dynamically as a function of data measured on the signal in the first digital component NUM1 and second digital component NUM2, or periodically, according to a frequency which is in the order of magnitude of the frequencies of the processed audio signal or which is a much lower frequency. In this case, the use of the analog processing stage ANA1 makes it possible to maintain the sound character provided by the use of the analog transistor while having the qualities of digital equalizations, as well as the tools for analyzing the signals and adapting the biases BIAS1, BIAS2 as a function of these analyses.

### Audio Processing Unit

The invention also relates to an audio processing unit for musical instrument comprising an audio processing device DIS1 according to the invention. The audio unit comprises a switch that can be activated by a user commanding the activation of the processing device DIS1. This switch controls the activation of the signal shunt element which allows the signal to pass through the processing device DIS1 without processing it. The audio processing unit also comprises at least one potentiometer that can be activated by a user making it possible to configure the first and second input parameters PARA1, PAR2. According to one embodiment, the audio processing unit comprises an electronic component and a memory, said memory recording a plurality of operating configurations of ranges of values of the first input parameters PARA1 with the second input parameters PARA2 and with the bias values BIAS1, the at least first actuator comprising positions that can be activated making it possible to select a given configuration recorded in the memory, said selection automatically configuring the processing device DIS1.

According to one embodiment shown in FIG. 6, the audio processing unit is an effect pedal for electric or electroacoustic guitar. In FIG. 6, the audio unit is plugged into an electric guitar on one side, and an electric guitar amplifier on the other side. The electric signal from the electric guitar is acquired by the input interface INT1 of the effect pedal, then processed by it, then transmitted via a cable to the amplifier. This audio unit comprises a switch that can be activated by foot commanding the activation of the processing device DIS1. It also comprises another switch configured to be activated by foot making it possible to select data configurations recorded in the memory. The manipulation of this switch also makes it possible to record a given configuration in the memory of the audio processing unit. The effect pedal also comprises three potentiometers making it possible to set the output level of the pedal signal, the equalization parameters, a saturation rate of the analog processing stage ANA1. The audio processing device also comprises a potentiometer making it possible to browse between several predefined operating points setting the parameters of the first equalization EGAL1, the second equalization EGAL2, the bias settings of the electronic components of the analog processing stage ANA1.

According to one embodiment, the audio processing unit is an amplifier for an electric instrument, such as an electric guitar. In this embodiment, the amplifier comprises at least the same settings as those described for the embodiment of the effects pedal.

According to one embodiment, the audio processing unit is a rack type audio unit comprising at least the same settings as those described for the embodiment relating to the effect pedal.

According to one embodiment, the audio processing unit is a mixing table comprising at least the same settings as those described for the embodiment relating to the effect pedal.

### Nomenclature:

DIS1: device for processing an audio signal
INT1: analog signal acquisition interface
INT2: analog signal output interface
NUM1: first digital component
NUM2: second digital component
CAN1: first analog-to-digital converter
CAN2: second analog-to-digital converter
NAC1: first digital-to-analog converter
CNA2: second digital-to-analog converter
CONT1: control digital-to-analog converter
COMP1: electronic component having a predefined non-linear operating range
S1: first analog input signal
S2: second digital signal
S3: third digital signal
S3′: third derived digital signal
S4: fourth analog signal
S5: fifth analog signal
S6: sixth digital signal
S7: seventh digital signal
S8: eighth analog signal
PARA1: first input parameters
PARA2: second input parameters
ANA1: analog processing stage
EGAL1: first digital equalization
EGAL2: second digital equalization
BIAS1, BIAS2, BIAS3, BIAS4: electronic component bias
CAPT: adjustment sensor
DI1, DI2: clipping diodes
DI2, DI3: light emitting diodes
AMP1, AMP2: operational amplifiers
OPT1: optocoupler
TRAN1: transistor

1. A device for processing an audio signal, comprising:
an acquisition interface of a first analog input signal from an audio source;
a first analog-to-digital converter of the first analog input signal to produce a second digital signal;
at least one first digital component to perform a first digital equalization of the second digital signal, said first digital equalization being configurable according to first input parameters, to produce a third digital signal;
a first digital-to-analog converter of the third digital signal to generate a fourth analog signal;
an analog processing stage comprising at least one electronic component having at least one predefined non-linear operating range, said analog processing stage being configured to process the fourth analog signal in at least a part of the non-linear operating range in order to generate a fifth analog signal;
a second analog-to-digital converter of the fifth analog signal to produce a sixth digital signal;
at least one second digital component to perform a second digital equalization of said sixth digital signal, said second digital equalization being configurable according to second input parameters, to produce a seventh digital signal,
the first digital component and/or the second digital component being configured to adjust a bias of the electronic component having at least one predefined non-linear operating range, the audio processing device further comprising at least one control digital-to-analog converter configured to provide at least one control analog signal adjusting the bias of the electronic component having at least one predefined non-linear operating range as a function of a first control datum provided by the first digital component and/or as a function of a second control datum provided by the second digital component

2. The device for processing an audio signal according to claim 1, further comprising:
a second digital-to-analog converter of the seventh digital output signal to produce an eighth analog signal; and
an output interface of the eighth analog output signal at the output of the first digital component.

3. The device for processing an audio signal according to claim 1, wherein the at least one electronic component having at least one predefined non-linear operating range of the analog processing stage is a diode, a transistor, an optocoupler or an amplification valve.

4. The device for processing an audio signal according to claim 1, wherein the first digital component comprises an analysis stage of the second digital signal, said analysis stage being configured to generate the first control datum as a function of at least one measured characteristic of a second digital signal.

5. The device for processing an audio signal according to claim 1, comprising a temperature sensor and/or a luminosity sensor and/or a hygrometry sensor.

6. The device for processing an audio signal according to claim 1, wherein the first digital component is configured to transmit a third derived digital signal to the second digital component which is configured to mix the third derived digital signal with the sixth digital signal.

7. An audio processing unit for musical instrument comprising a processing device according to claim 1, said audio processing unit comprising a switch commanding the activation of the processing device, at least one first actuator for configuring the first input parameters and/or the second input parameters and/or the bias.

8. A method for processing an audio signal, comprising:
an acquisition of a first analog input signal from a musical instrument/voice;
a first analog-to-digital conversion of the first analog input signal to produce a second digital signal;
at least one first equalization of the second digital signal by a first digital component, said first digital equalization being configurable according to first input parameters, to produce a third digital signal;
a first digital-to-analog conversion of the third digital signal to generate a fourth analog signal;
an analog processing, by an analog processing stage comprising at least one electronic component having at least one predefined non-linear operating range, of the fourth analog signal in at least a part of the non-linear operating range in order to generate a fifth analog signal;
an adjustment of the bias of the electronic component having at least one predefined non-linear operating range by the first digital component and/or the second digital component, the adjustment being performed by at least one control digital-to-analog converter configured to provide at least one control analog signal adjusting the bias of the electronic component having at least one predefined non-linear operating range as a function of a first control datum provided by the first digital component and/or as a function of a second control datum provided by the second digital component;
a second analog-to-digital conversion of the fifth analog signal to produce a sixth digital signal;
a second digital equalization of the sixth digital signal by at least one second digital component, said second digital equalization being configurable according to second input parameters, to produce a seventh digital signal;
a second digital-to-analog conversion of the seventh digital output signal to produce an eighth analog signal; and
an output of the eighth analog signal via an output interface.

9. The device for processing an audio signal according to claim 4, wherein the at least one measured characteristic of a second digital signal includes an envelope detection datum of the second digital signal and/or a datum generated as a function of a harmonic analysis of the second signal and/or an amplitude datum of the second digital signal.
